(19) United States
(12) Patent Application Publication
(10) Pub. No.: US 2016/0272047 A1
(43) Pub. Date: Sep. 22, 2016

(54) CAPACITY MODULATION OF TRANSPORT REFRIGERATION SYSTEM

(71) Applicant: CARRIER CORPORATION, Farmington, CT (US)

(72) Inventor: Mingfei Gan, Manlius, NY (US)

(21) Appl. No.: 14/777,846

(22) PCT Filed: Mar. 14, 2014
(86) PCT No.: PCT/US14/27240

§ 371 Date: Sep. 17, 2015

Related U.S. Application Data
(60) Provisional application No. 61/803,821, filed on Mar. 21, 2013.

(51) Int. Cl. B60H 1/32; F25B 9/00; B60H 1/00

(52) U.S. Cl. CPC B60H 1/3211; B60H 1/00364; B60H 1/3232; B60H 1/3216; F25B 9/008; F25B 2400/13; F25B 2600/0261; F25B 2500/18

(57) ABSTRACT

A refrigerant vapor compression system includes a compression device having at least a first compression stage (30a) and a second compression stage (30b) arranged in series refrigerant flow relationship; a first refrigerant heat rejection heat exchanger (80) disposed intermediate the first compression stage and the second compression stage for passing the refrigerant passing from the first compression stage to the second compression stage; a second refrigerant heat rejection heat exchanger (40) disposed downstream with respect to refrigerant flow of the second compression stage; a bypass line (90,130) positioned at least one of a discharge outlet port of the first compression stage and a discharge outlet port of the second compression stage; a bypass valve (92,132) disposed in the bypass line, at least one of the first compression stage and second compression stage bypassed and at least one of the first refrigerant heat rejection heat exchanger and the second refrigerant heat rejection heat exchanger bypassed.

### FIELD OF INVENTION

The subject matter disclosed herein relates generally to the field of transport refrigeration systems, and more particularly, to capacity modulation of a transport refrigeration system.

### BACKGROUND

Refrigerant vapor compression systems are well known in the art and commonly used for conditioning air to be supplied to a climate controlled comfort zone within a residence, office building, hospital, school, restaurant or other facility. Refrigerant vapor compression systems are also commonly used in refrigerating air supplied to display cases, merchandisers, freezer cabinets, cold rooms or other perishable/frozen product storage area in commercial establishments. Refrigerant vapor compression systems are also commonly used in transport refrigeration systems for refrigerating air supplied to a temperature controlled cargo space of a truck, trailer, container or the like for transporting perishable/frozen items by truck, rail, ship or intermodally.

Refrigerant vapor compression systems used in connection with transport refrigeration systems are generally subject to more stringent operating conditions due to the wide range of operating load conditions and the wide range of outdoor ambient conditions over which the refrigerant vapor compression system must operate to maintain product within the cargo space at a desired temperature. The desired temperature at which the cargo needs to be controlled can also vary over a wide range depending on the nature of cargo to be preserved. The refrigerant vapor compression system must not only have sufficient capacity to rapidly pull down the temperature of product loaded into the cargo space at ambient temperature, but also should operate energy efficiently over the entire load range, including at low load when maintaining a stable product temperature at low ambient temperature during transport.

Existing transport refrigeration systems have difficulty in reducing capacity at low ambient conditions. To achieve low capacity, existing refrigerant vapor compression systems either cycle the compressor on/off or add heat into controlled space. Cycling the refrigerant vapor compression system on/off causes a large fluctuation on control temperature. Adding heat (e.g., through electrical resistance heaters) is energy inefficient and may lead to dehydration of the perishable cargo.

### BRIEF SUMMARY

According to an exemplary embodiment a refrigerant vapor compression system includes a compression device having at least a first compression stage and a second compression stage arranged in series refrigerant flow relationship; a first refrigerant heat rejection heat exchanger disposed intermediate the first compression stage and the second compression stage for passing the refrigerant passing from the first compression stage to the second compression stage; a second refrigerant heat rejection heat exchanger disposed downstream with respect to refrigerant flow of the second compression stage; a bypass line positioned at at least one of a discharge outlet port of the first compression stage and a discharge outlet port of the second compression stage; a bypass valve disposed in the bypass line, the bypass valve allowing or preventing refrigerant flow through the bypass line; wherein when the bypass valve allows refrigerant flow through the bypass line, at least one of the first compression stage and the second compression stage is bypassed and at least one of the first refrigerant heat rejection heat exchanger and the second refrigerant heat rejection heat exchanger is bypassed.

According to another exemplary embodiment, a refrigerant vapor compression system includes a compression device having at least a first compression stage and a second compression stage arranged in series refrigerant flow relationship; a refrigerant heat rejection heat exchanger disposed downstream of one of the first compression stage and the second compression stage; a bypass line; a bypass valve disposed in the bypass line, the bypass valve allowing or preventing refrigerant flow through the bypass line; wherein when the bypass valve allows refrigerant flow through the bypass line, at least one of the first compression stage and the second compression stage is bypassed and the refrigerant heat rejection heat exchanger is bypassed.

Other aspects, features, and techniques of embodiments of the invention will become more apparent from the following description taken in conjunction with the drawings.

### BRIEF DESCRIPTION OF THE DRAWINGS

Referring now to the drawings wherein like elements are numbered alike in the FIGURES:

FIG. 1 depicts a refrigerated container in an exemplary embodiment;

FIG. 2 depicts a refrigerant vapor compression system in an exemplary embodiment;

FIG. 3 depicts a refrigerant vapor compression system in an exemplary embodiment; and

FIG. 4 depicts a refrigerant vapor compression system in an exemplary embodiment

### DETAILED DESCRIPTION

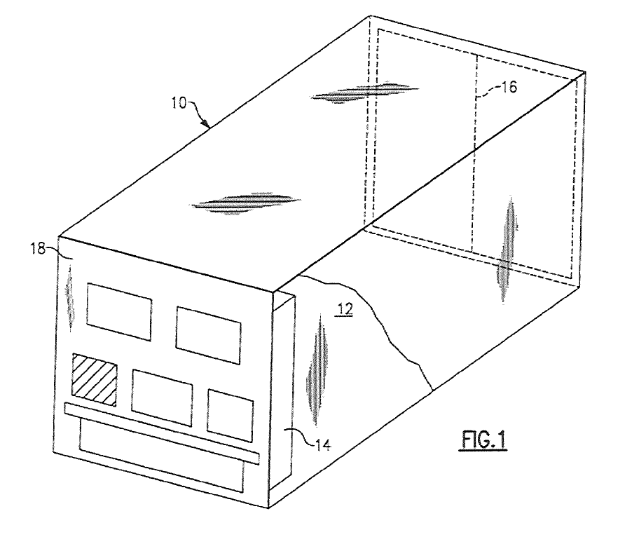

FIG. 1 depicts an exemplary embodiment of a refrigerated container 10 having a temperature controlled cargo space 12, the atmosphere of which is refrigerated by operation of a refrigeration unit 14 associated with the cargo space 12. In the depicted embodiment of the refrigerated container 10, the refrigeration unit 14 is mounted in a wall of the refrigerated container 10, typically in the front wall 18 in conventional practice. However, the refrigeration unit 14 may be mounted in the roof, floor or other walls of the refrigerated container 10. Additionally, the refrigerated container 10 has at least one access door 16 through which perishable goods, or frozen food products, may be loaded into and removed from the cargo space 12 of the refrigerated container 10.

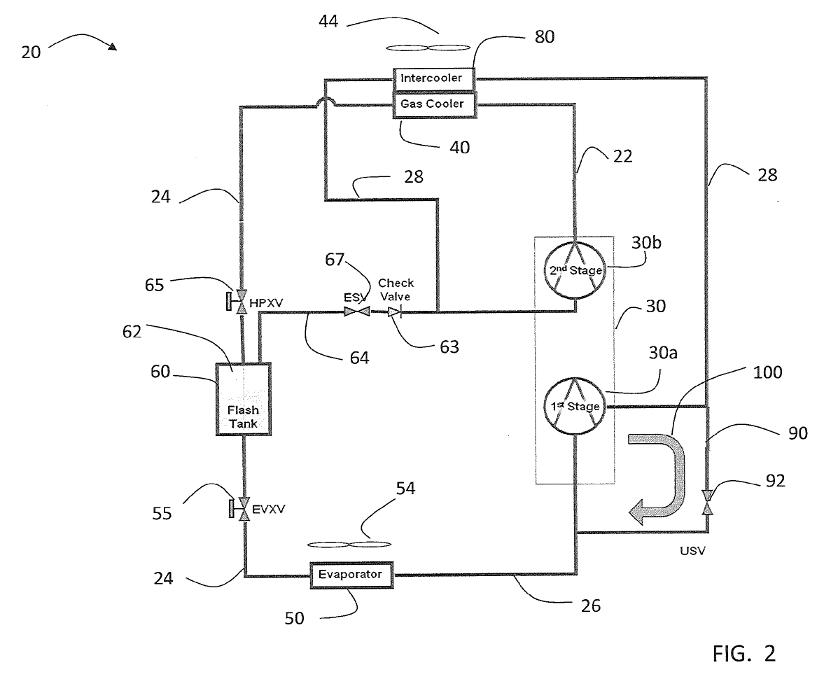

FIG. 2 depicts an exemplary refrigerant vapor compression system 20 suitable for use in the refrigeration unit 14 for refrigerating air drawn from and supplied back to the temperature controlled cargo space 12. Although the refrigerant vapor compression system 20 will be described herein in connection with a refrigerated container 10 of the type commonly used for transporting perishable goods by ship, by rail, by land or intermodally, it is to be understood that the refrigerant vapor compression system 20 may also be used in refrigeration units for refrigerating the cargo space of a truck, a trailer or the like for transporting perishable goods. The refrigerant vapor compression system 20 is also suitable for use in conditioning air to be supplied to a climate controlled comfort zone within a residence, office building, hospital, school, restaurant or other facility. The refrigerant vapor compression system 20 could also be employed in refrigerating air supplied to display cases, merchandisers, freezer cabinets, cold rooms or other perishable and frozen product storage areas in commercial establishments.

The refrigerant vapor compression system 20 includes a multi-stage compression device 30, a refrigerant heat rejection heat exchanger 40, a refrigerant heat absorption heat exchanger 50, also referred to herein as an evaporator, and a primary expansion device 55, such as for example an electronic expansion valve or a thermostatic expansion valve, operatively associated with the evaporator 50, with various refrigerant lines 22, 24, 26, and 28 connecting the aforementioned components in a primary refrigerant circuit. The refrigerant heat rejection heat exchanger 40 is shown as a gas cooler, but may operate as a condenser as described herein.

The compression device 30 functions to compress the refrigerant and to circulate refrigerant through the primary refrigerant circuit as will be discussed in further detail hereinafter. The compression device 30 may comprise a single, multiple-stage refrigerant compressor, for example a reciprocating compressor, having a first compression stage 30a and a second compression stage 30b, or may comprise a pair of compressors 30a and 30b, connected in series refrigerant flow relationship in the primary refrigerant circuit via a refrigerant line 28 connecting the discharge outlet port of the first compression stage compressor 30a in refrigerant flow communication with the suction inlet port of the second compression stage compressor 30b. The first and second compression stages 30a and 30b are disposed in series refrigerant flow relationship with the refrigerant leaving the first compression stage 30a passing to the second compression stage 30b for further compression. In the first compression stage, the refrigerant vapor is compressed from a lower pressure to an intermediate pressure. In the second compression stage, the refrigerant vapor is compressed from an intermediate pressure to higher pressure. In a two compressor embodiment, the compressors may be scroll compressors, screw compressors, reciprocating compressors, rotary compressors or any other type of compressor or a combination of any such compressors.

The refrigerant heat rejection heat exchanger 40 may comprise a finned tube heat exchanger through which hot, high pressure refrigerant discharged from the second compression stage 30b (e.g., the final compression charge) passes in heat exchange relationship with a secondary fluid, most commonly ambient air drawn through the heat rejection heat exchanger 40 by the fan(s) 44. The finned heat rejection heat exchanger 40 may comprise, for example, a fin and round tube heat exchange coil or a fin and flat mini-channel tube heat exchanger. If the pressure of the refrigerant discharging from the second compression stage 30b, commonly referred to as the compressor discharge pressure, exceeds the critical point of the refrigerant, the refrigerant vapor compression system 20 operates in a transcritical cycle and the refrigerant heat rejection heat exchanger 40 functions as a gas cooler. If the compressor discharge pressure is below the critical point of the refrigerant, the refrigerant vapor compression system 20 operates in a subcritical cycle and the refrigerant heat rejection heat exchanger 40 functions as a condenser.

The refrigerant heat absorption heat exchanger 50 may also comprise a finned tube coil heat exchanger, such as a fin and round tube heat exchanger or a fin and flat, mini-channel tube heat exchanger. The refrigerant heat absorption heat exchanger 50 functions as a refrigerant evaporator whether the refrigerant vapor compression system is operating in a transcritical cycle or a subcritical cycle. Before entering the refrigerant heat absorption heat exchanger 50, the refrigerant passing through refrigerant line 24 traverses the expansion device 55, such as, for example, an electronic expansion valve or a thermostatic expansion valve, and expands to a lower pressure and a lower temperature to enter heat absorption heat exchanger 50. As the liquid refrigerant traverses the refrigerant heat absorption heat exchanger 50, the liquid refrigerant passes in heat exchange relationship with a heating fluid whereby the liquid refrigerant is evaporated and typically superheated to a desired degree. The low pressure vapor refrigerant leaving heat absorption heat exchanger 50 passes through refrigerant line 26 to the suction inlet port of the first compression stage 30a. The heating fluid may be air drawn by an associated fan(s) 54 from a climate controlled environment, such as a perishable/frozen cargo storage zone associated with a transport refrigeration unit, or a food display or storage area of a commercial establishment, or a building comfort zone associated with an air conditioning system, to be cooled, and generally also dehumidified, and thence returned to a climate controlled environment.

The refrigerant vapor compression system 20 further includes an economizer circuit associated with the primary refrigerant circuit. The economizer circuit includes an economizer device 60, an economizer circuit expansion device 65, and a vapor injection line 64 in refrigerant flow communication with an intermediate pressure stage of the compression process. In the embodiments depicted in FIG. 2, the economizer device comprises a flash tank economizer 60. It is understood that other types of economizer devices may be used, such as a refrigerant-to-refrigerant heat exchanger. The economizer expansion device 65 may, for example, be an electronic expansion valve, a thermostatic expansion valve or a fixed orifice expansion device.

Flash tank economizer 60 is interdisposed in refrigerant line 24 between the refrigerant heat rejection heat exchanger 40 and the primary expansion device 55. The economizer circuit expansion device 65 is disposed in refrigerant line 24 upstream of the flash tank economizer 60. The flash tank economizer 60 defines a chamber 62 into which expanded refrigerant having traversed the economizer circuit expansion device 65 enters and separates into a liquid refrigerant portion and a vapor refrigerant portion. The liquid refrigerant collects in the chamber 62 and is metered therefrom through the downstream leg of refrigerant line 24 by the primary expansion device 55 to flow to the refrigerant heat absorption heat exchanger 50. The vapor refrigerant collects in the chamber 62 above the liquid refrigerant and passes therefrom through vapor injection line 64 for injection of refrigerant vapor into an intermediate stage of the compression device 30.

The vapor injection line 64 communicates with refrigerant line 28 downstream of intercooler 80, interconnecting the outlet of the first compression stage 30a to the inlet of the second compression stage 30b. A check valve 63 may be interdisposed in vapor injection line 64 upstream of its connection with refrigerant line 28 to prevent backflow through vapor injection line 64. An economizer solenoid valve (ESV) 67 may be interdisposed in vapor injection line 64 to enable or disable operation of the refrigeration system 20 in economizer mode. It is to be understood, however, that refrigerant vapor injection line 64 can open directly into an intermediate stage of the compression device 30 rather than opening into refrigerant line 28.

To improve the energy efficiency and cooling capacity of the refrigerant vapor compression system 20, particularly when operating in a transcritical cycle and charged with carbon dioxide or a mixture including carbon dioxide as the refrigerant, the refrigerant vapor compression system 20 includes a further refrigerant heat rejecting heat exchanger in the form of an intercooler 80. Intercooler 80 is interdisposed in refrigerant line 28 of the primary refrigerant circuit between the first compression stage 30a and the second compression stage 30b, as depicted in FIG. 2. The intercooler 80 comprises a refrigerant-to-secondary fluid heat exchanger, such as for example a finned tube heat exchanger, through which intermediate temperature, intermediate pressure refrigerant passing from the first compression stage 30a to the second compression stage 30b passes in heat exchange relationship with ambient air drawn through the intercooler 80 by the fan(s) 44. The intercooler 80 may comprise, for example, a fin and round tube heat exchange coil or a fin and flat mini-channel tube heat exchanger.

As noted above, it is necessary to reduce capacity of the refrigerant vapor compression system at times (e.g., at low ambient temperature). In the embodiment of FIG. 2, a bypass line 90 connects a discharge outlet port of the first compression stage 30a to an suction inlet port of the first compression stage 30a. Bypass line 90 also connects refrigerant line 28 (inlet to intercooler 80) to refrigerant line 26 (outlet of evaporator 50). A bypass valve 92 is positioned in the bypass line 90 and may be opened or closed by a controller to control capacity of the refrigerant vapor compression system 20. Bypass valve 92 may be a solenoid valve, having open-closed states, or an electronically controlled valve providing a multitude of flow rates.

FIG. 2 depicts a mode where bypass valve 92 is open. Arrow 100 indicates a flow of refrigerant from the discharge outlet port of first compression stage 30a to a suction inlet port of first compression stage 30a. It is noted that intercooler 80 is also bypassed, by virtue of the bypass line 90 being connected to refrigerant line 28, the inlet to intercooler 80, and refrigerant line 26, inlet to first compression stage 30a. Thus, the system of FIG. 2 provides a bypass of one compression stage (e.g., first compression stage 30a) and one refrigerant heat rejecting heat exchanger (e.g., intercooler 80).

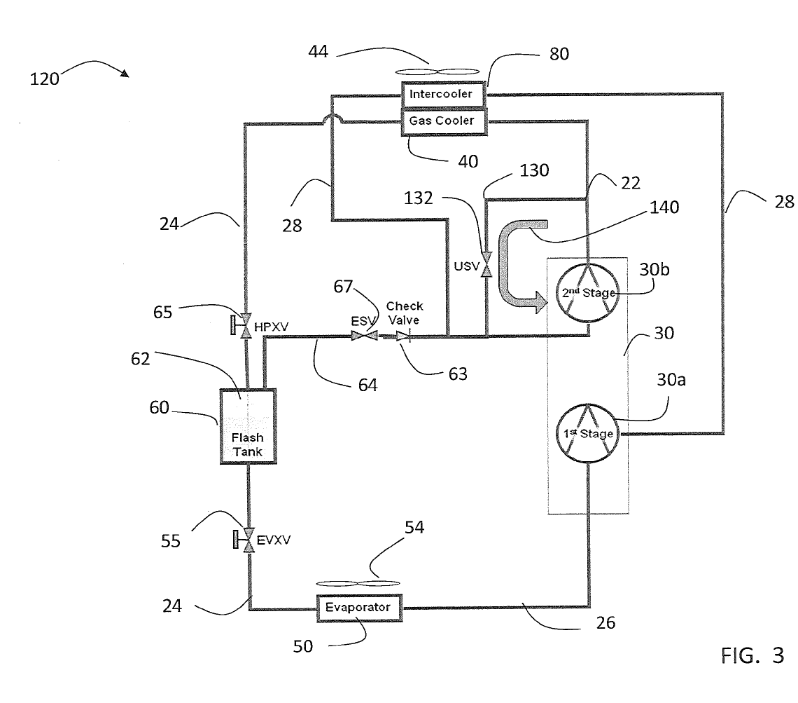

FIG. 3 depicts an exemplary refrigerant vapor compression system 120 suitable for use in the refrigeration unit 14 for refrigerating air drawn from and supplied back to the temperature controlled cargo space 12. Elements of refrigeration system 120 corresponding to elements in FIG. 2 are labeled with the same reference numeral. In the embodiment of FIG. 3, a bypass line 130 connects a discharge outlet port of the second compression stage 30b to a suction inlet port of the second compression stage 30b. Bypass line 130 also connects refrigerant line 22 (inlet to gas cooler 40) to refrigerant line 64 (outlet of economizer 60). A bypass valve 132 is positioned in the bypass line 130 and may be opened or closed by a controller to control capacity of the refrigerant vapor compression system 120. Bypass valve 132 may be a solenoid valve, having open-closed states, or an electronically controlled valve providing a multitude of flow rates.

FIG. 3 depicts a mode where bypass valve 132 is open. Arrow 140 indicates a flow of refrigerant from the discharge outlet port of second compression stage 30b to a suction inlet port of second compression stage 30b. It is noted that gas cooler 40 is also bypassed, by virtue of the bypass line 130 being connected to refrigerant line 22, the inlet to gas cooler 40, and vapor injection line 64, inlet to second compression stage 30b. Thus, the system of FIG. 3 provides a bypass of one compression stage (e.g., second compression stage 30b) and one refrigerant heat rejecting heat exchanger (e.g., gas cooler 40).

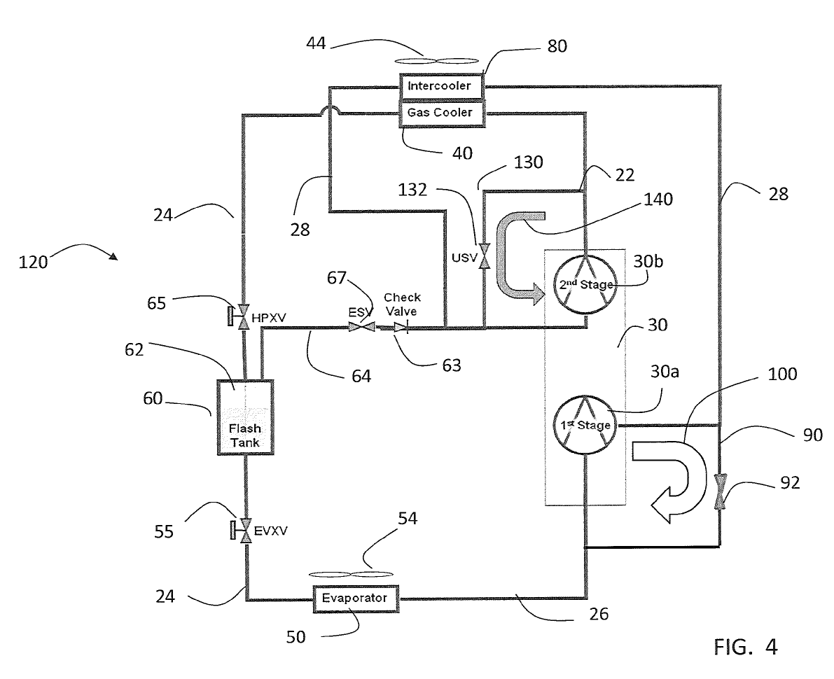

The bypass line 90 and bypass valve 92 of FIG. 2 may be used in conjunction with bypass line 130 and bypass valve 132 of FIG. 3. FIG. 4 depicts an exemplary embodiment including bypass line 90, bypass valve 92, bypass line 130 and bypass valve 132. If both bypass valve 90 and bypass valve 132 are open, then all of first compression stage 30a, second compression stage 30b, first refrigerant heat rejecting heat exchanger 80 and second refrigerant heat rejecting heat exchanger 40 are bypassed, to further reduce capacity.

The capacity modulation embodiments disclosed herein may also be used in conjunction with other capacity modulation techniques. For example, embodiments disclosed herein may be used along with a variable frequency drive (VFD) to modulate the compressor capacity. Alternatively, embodiments disclosed herein may be used along digital scroll compressor providing capacity modulation. Other known capacity modulation techniques may be used with the embodiments disclosed herein.

Embodiments described herein reduce the cooling capacity of the refrigerant vapor compression system without compromising temperature control and cargo quality/energy efficiency. In addition, compressor reliability can be improved by preventing condensated refrigerant from entering the compressor through intermediate heat rejection device 80, for example.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as being limited by the foregoing description, but is only limited by the scope of the appended claims. Features shown with one embodiment may be used with any other embodiment even if not described with the other embodiments.

1. A refrigerant vapor compression system comprising:
a compression device having at least a first compression stage and a second compression stage arranged in series refrigerant flow relationship;
a first refrigerant heat rejection heat exchanger disposed intermediate the first compression stage and the second compression stage for passing refrigerant passing from the first compression stage to the second compression stage;
a second refrigerant heat rejection heat exchanger disposed downstream with respect to refrigerant flow of the second compression stage;
a bypass line positioned at at least one of a discharge outlet port of the first compression stage and a discharge outlet port of the second compression stage;
a bypass valve disposed in the bypass line, the bypass valve allowing or preventing refrigerant flow through the bypass line;
wherein when the bypass valve allows refrigerant flow through the bypass line, at least one of the first compression stage and the second compression stage is bypassed and at least one of the first refrigerant heat rejection heat exchanger and the second refrigerant heat rejection heat exchanger is bypassed.

2. The refrigerant vapor compression system of claim 1 further comprising:
a refrigerant line connecting the discharge outlet port of the first compression stage to an inlet of the first refrigerant heat rejection heat exchanger;
wherein the bypass line connects the discharge outlet port of the first compression stage to an suction inlet port of the first compression stage; and
the bypass line connects the refrigerant line to the suction inlet port of the first compression stage.

3. The refrigerant vapor compression system of claim 1 further comprising:
a refrigerant line connecting the discharge outlet port of the second compression stage to an inlet of the second refrigerant heat rejection heat exchanger;
wherein the bypass line connects the discharge outlet port of the second compression stage to an suction inlet port of the second compression stage; and
the bypass line connects the refrigerant line to the suction inlet port of the second compression stage.

4. The refrigerant vapor compression system of claim 1 wherein:
the bypass line includes a first bypass line and a second bypass line, the first bypass line connecting the discharge outlet port of the first compression stage to an suction inlet port of the first compression stage, the first bypass line connecting the discharge outlet port of the second compression stage to an suction inlet port of the second compression stage;
the bypass valve includes a first bypass valve and a second bypass valve, the first bypass valve disposed in the first bypass line, the first bypass valve allowing or preventing refrigerant flow through the first bypass line, the second bypass valve disposed in the second bypass line, the second bypass valve allowing or preventing refrigerant flow through the second bypass line; and
when the first bypass valve allows refrigerant flow through the first bypass line and the second bypass valve allows refrigerant flow through the second bypass line, each of the first compression stage, the second compression stage, the first refrigerant heat rejection heat exchanger and the second refrigerant heat rejection heat exchanger is bypassed.

5. The refrigerant vapor compression system of claim 4 further comprising:
a first refrigerant line connecting the discharge outlet port of the first compression stage to an inlet of the first refrigerant heat rejection heat exchanger;
wherein the first bypass line connects the first refrigerant line to the suction inlet port of the first compression stage.

6. The refrigerant vapor compression system of claim 5 further comprising:
a second refrigerant line connecting the discharge outlet port of the second compression stage to an inlet of the second refrigerant heat rejection heat exchanger;
the second bypass line connecting the second refrigerant line to the suction inlet port of the second compression stage.

7. The refrigerant vapor compression system of claim 1 further comprising:
an economizer disposed downstream with respect to refrigerant flow of the second refrigerant heat rejection heat exchanger;
a vapor injection line communicating refrigerant from the economizer to a suction inlet port of the second compression stage.

8. The refrigerant vapor compression system of claim 7 further comprising:
a refrigerant heat absorption heat exchanger disposed downstream with respect to refrigerant flow of the economizer;
an outlet of the refrigerant heat absorption heat exchanger coupled to the suction inlet port of the first compression stage.

9. The refrigerant vapor compression system of claim 7 wherein:
the economizer is a flash tank economizer.

10. The refrigerant vapor compression system of claim 7 wherein:
the economizer is a refrigerant-to-refrigerant heat exchanger.

11. The refrigerant vapor compression system of claim 1 wherein:
the refrigerant comprises carbon dioxide.

12. The refrigerant vapor compression system of claim 1 further comprising at least one fan operatively associated with the first refrigerant heat rejection heat exchanger and the second refrigerant heat rejection heat exchanger for moving a flow of air through the first refrigerant heat rejection heat exchanger and the second refrigerant heat rejection heat exchanger.

13. A refrigerated container for use in transporting perishable goods including a refrigeration system incorporating the refrigerant vapor compression system as recited in claim 1.

14. A refrigerant vapor compression system comprising:
a compression device having at least a first compression stage and a second compression stage arranged in series refrigerant flow relationship;
a refrigerant heat rejection heat exchanger disposed downstream of one of the first compression stage and the second compression stage;
a bypass line;
a bypass valve disposed in the bypass line, the bypass valve allowing or preventing refrigerant flow through the bypass line;
wherein when the bypass valve allows refrigerant flow through the bypass line, at least one of the first compression stage and the second compression stage is bypassed and the refrigerant heat rejection heat exchanger is bypassed.
